(19) United States
(12) Patent Application Publication
(10) Pub. No.: US 2025/0384071 A1
(43) Pub. Date: Dec. 18, 2025

(54) TECHNOLOGIES RELATING TO GENERATING KNOWLEDGE BASE ANSWERS IN REAL TIME TO ASSIST AGENTS DURING LIVE INTERACTIONS

(71) Applicant: Genesys Cloud Services, Inc., Menlo Park, CA (US)

(72) Inventors: Basil George, Hyderabad (IN); Ved Purushottam Abhyanker, Hyderabad (IN); Ramasubramanian Sundaram, Hyderabad (IN); Manish Kumar Singh, Hyderabad (IN); Sarnendu Raha, Hyderabad (IN)

(21) Appl. No.: 19/236,216

(22) Filed: Jun. 12, 2025

Related U.S. Application Data
(60) Provisional application No. 63/660,686, filed on Jun. 17, 2024.

(51) Int. Cl. G06F 16/338; G06F 16/3329; G06F 16/35; G06F 40/30; H04L 51/02

(52) U.S. Cl. CPC G06F 16/338; G06F 16/33295; G06F 16/35; G06F 40/30; H04L 51/02

(57) ABSTRACT

A method for efficient identification of knowledge base data to support interactions in a contact center may include identifying a query associated with a contemporaneous interaction between a client and an agent of a contact center and performing a search of a knowledge base to determine a set of one or more relevant documents responsive to the identified query, including ranking a set of resultant documents from the knowledge base as a function of a vector-based similarity determination in which each resultant document and the identified query is represented with a corresponding embedding. Additionally, the method may include identifying, with a transformer-based artificial intelligence model, a subset of content within each relevant document as being most pertinent to the identified query and visually demarcating the identified subset of each relevant document from other content of the relevant document in a user interface as the interaction occurs.

### CROSS-REFERENCE TO RELATED APPLICATIONS

This application claims priority to and the benefit of U.S. Provisional Application No. 63/660,686 titled “TECHNOLOGIES RELATING TO GENERATING KNOWLEDGE BASE ANSWERS IN REAL TIME TO ASSIST AGENTS DURING LIVE INTERACTIONS WITH CUSTOMERS,” filed on Jun. 17, 2024, the contents of which are incorporated herein by reference in their entirety.

### BACKGROUND

In a contact center, agents may interact with clients through communication channels to provide support, such as in relation to one or more products or services offered by an organization. In some instances, an agent may not have an immediate answer to provide in response to a question posed by a user/client. In an attempt to answer the question, the agent may resort to a set of information, such as a set of documents, that generally relate to the topic to which the question pertains. However, in conventional systems, enabling the agent to identify a relevant document and specific information within the document that is pertinent to the question within a target time span for the interaction may not be technically feasible.

### SUMMARY

One embodiment is directed to a unique system, components, and methods for generating knowledge base answers in real time to assist agents during live interactions. Other embodiments are directed to apparatuses, systems, devices, hardware, methods, and combinations thereof for generating knowledge base answers in real time to assist agents during live interactions.

According to an embodiment, a method for efficient identification of knowledge base data to support interactions in a contact center may include identifying, by a computing system, a query associated with a contemporaneous interaction between a client and an agent of a contact center. The method may also include performing, by the computing system and as a function of the identified query, a search of a knowledge base to determine a set of one or more relevant documents responsive to the identified query, including ranking a set of resultant documents from the knowledge base as a function of a vector-based similarity determination in which each resultant document and the identified query is represented with a corresponding embedding. Additionally, the method may include identifying, by the computing system and with a transformer-based artificial intelligence model trained to perform extractive question answering, a subset of content within each relevant document as being most pertinent to the identified query. Further, the method may include providing, by the computing system, the identified subset of the content of each relevant document to the agent during the interaction with the client, including visually demarcating the identified subset of each relevant document from other content of the relevant document in a user interface that is representative of the interaction as the interaction occurs.

In some embodiments, identifying the query comprises identifying, in an auto-suggestion mode, each of multiple communications of the client in the interaction as a separate query.

In some embodiments, identifying the query comprises identifying a query provided by the agent via the user interface that is representative of the interaction during the interaction.

In some embodiments, identifying the subset of the content within each relevant document comprises extracting text from each relevant document, performing, with the artificial intelligence model, inference operations on the extracted text to determine a subset of the extracted text as being most pertinent to the query, and performing post processing operations on each relevant document to demarcate the subset of extracted text from other content of the relevant document, including determining the location of the subset of the extracted text within the relevant document.

In some embodiments, performing inference operations further comprises providing the extracted text to the artificial intelligence model in a prompt that includes the identified query and an instruction to identify the subset of text that is most pertinent to the identified query.

In some embodiments, performing inference operations with a transformer based artificial intelligence model comprises performing the inference operations with a large language model.

In some embodiments, visually demarcating the identified subset of each relevant document comprises highlighting the identified subset of each relevant document in the user interface.

In some embodiments, providing the identified subset of the content of each relevant document to the agent comprises displaying the identified subset in conjunction with a transcript of at least a portion of the interaction in the user interface.

In some embodiments, providing the identified subset of the content of each relevant document to the agent comprises displaying the identified subset in a chat interface that is representative of the interaction.

In some embodiments, providing the identified subset of the content of each relevant document to the agent comprises displaying the identified query with the identified subset of the content.

According to another embodiment, a system for efficient identification of knowledge base data to support interactions in a contact center may include at least one processor and at least one memory comprising a plurality of instructions stored thereon that, in response to execution by the at least one processor, causes the system to identify a query associated with a contemporaneous interaction between a client and an agent of a contact center. The instructions may also cause the system to perform, as a function of the identified query, a search of a knowledge base to determine a set of one or more relevant documents responsive to the identified query, wherein to perform the search includes to rank a set of resultant documents from the knowledge base as a function of a vector-based similarity determination in which each resultant document and the identified query is represented with a corresponding embedding. Further, the instructions may cause the system to identify, with a transformer-based artificial intelligence model trained to answer questions with text extraction, a subset of content within each relevant document as being most pertinent to the identified query. Additionally, the instructions may cause the system to provide the identified subset of the content of each relevant document to the agent during the interaction with the client, wherein to provide the identified subset includes to visually demarcate the identified subset of each relevant document from other content of the relevant document in a user interface that is representative of the interaction as the interaction occurs.

In some embodiments, to identify the query comprises to identify, in an auto-suggestion mode, each of multiple communications of the client in the interaction as a separate query.

In some embodiments, to identify the query comprises to identify a query provided by the agent via the user interface that is representative of the interaction during the interaction.

In some embodiments, to identify the subset of the content within each relevant document comprises to extract text from each relevant document, perform, with the artificial intelligence model, inference operations on the extracted text to determine a subset of the extracted text as being most pertinent to the query, and perform post process operations on each relevant document to demarcate the subset of extracted text from other content of the relevant document, wherein to perform the post process operations include to determine the location of the subset of the extracted text within the relevant document.

In some embodiments, to perform inference operations further comprises to provide the extracted text to the artificial intelligence model in a prompt that includes the identified query and an instruction to identify the subset of text that is most pertinent to the identified query.

In some embodiments, to perform inference operations with a transformer based artificial intelligence model comprises to perform the inference operations with a large language model.

In some embodiments, to visually demarcate the identified subset of each relevant document comprises to highlight the identified subset of each relevant document in the user interface.

In some embodiments, to provide the identified subset of the content of each relevant document to the agent comprises to display the identified subset in conjunction with a transcript of at least a portion of the interaction in the user interface.

In some embodiments, to provide the identified subset of the content of each relevant document to the agent comprises to display the identified subset in a chat interface that is representative of the interaction.

In some embodiments, to provide the identified subset of the content of each relevant document to the agent comprises to display the identified query with the identified subset of the content.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIGS. 3-5 are a simplified flow diagram of at least one embodiment of a method of efficiently identifying knowledge base data to support interactions in a contact center;

FIG. 6-7 are diagrams of user interfaces that may be produced by the contact center system to efficiently provide knowledge base data to support an ongoing interaction between an agent and a client;

FIG. 8 illustrates a rendering of a document that may be present in a knowledge base utilized by the contact center; and

FIGS. 9-15 illustrates sample code that defines the document represented in FIG. 8.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The technologies described herein pertain to contact centers and associated cloud-based systems. More particularly, the technologies described herein relate to the generation of knowledge base answers for contact center agents during live interactions with clients (e.g., customers, individuals who contact the contact center, etc.). Further, and as described in more detail herein, system and methods disclosed herein enable the determination of documents that are relevant to a given query based on an ongoing interaction between an agent and a client, the identification of specific content within the relevant document(s) that are most pertinent to the query, and the display of that most pertinent content to the agent, such as via a user interface, as the interaction takes place (e.g., in real time). The technologies utilize a series of artificial intelligence related operations and a specially trained transformer-based artificial intelligence model to provide the pertinent content to the agent (e.g., to a computing device of an agent) in real time. These features, which represent technical improvements over conventional systems utilized in contact centers, are described in more detail herein.

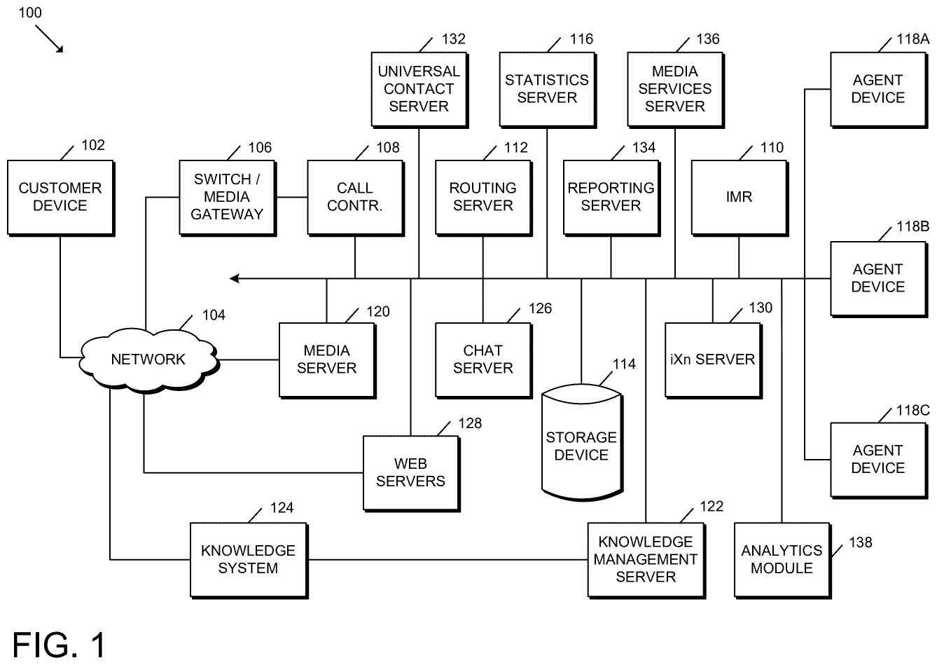

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to a customer and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

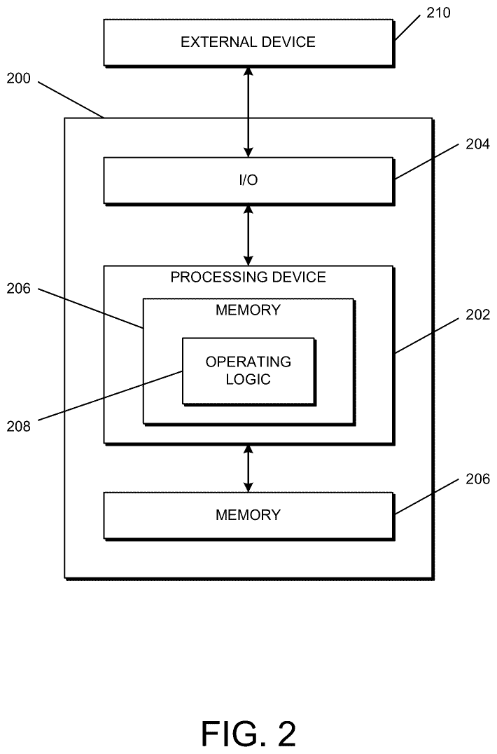

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices-represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein-such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

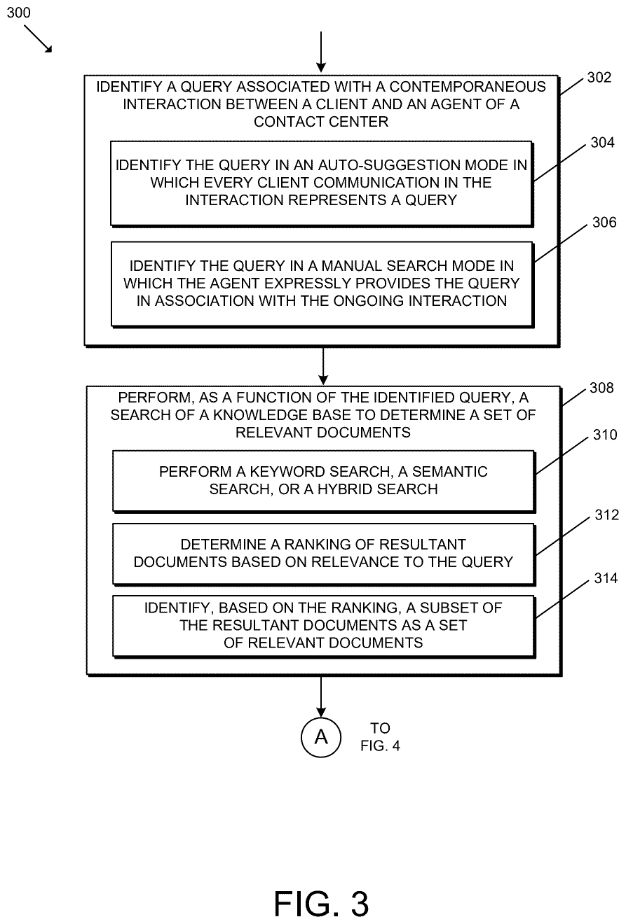

Referring now to FIG. 3, in use, a computing system (e.g., the contact center system 100, one or more computing devices 200, and/or other computing devices described herein) may execute a method 300 for efficiently identifying knowledge base data to support interactions in a contact center. It should be appreciated that the particular blocks of the method 300 are illustrated by way of example, and such blocks may be combined or divided, added or removed, and/or reordered in whole or in part depending on the particular embodiment, unless stated to the contrary.

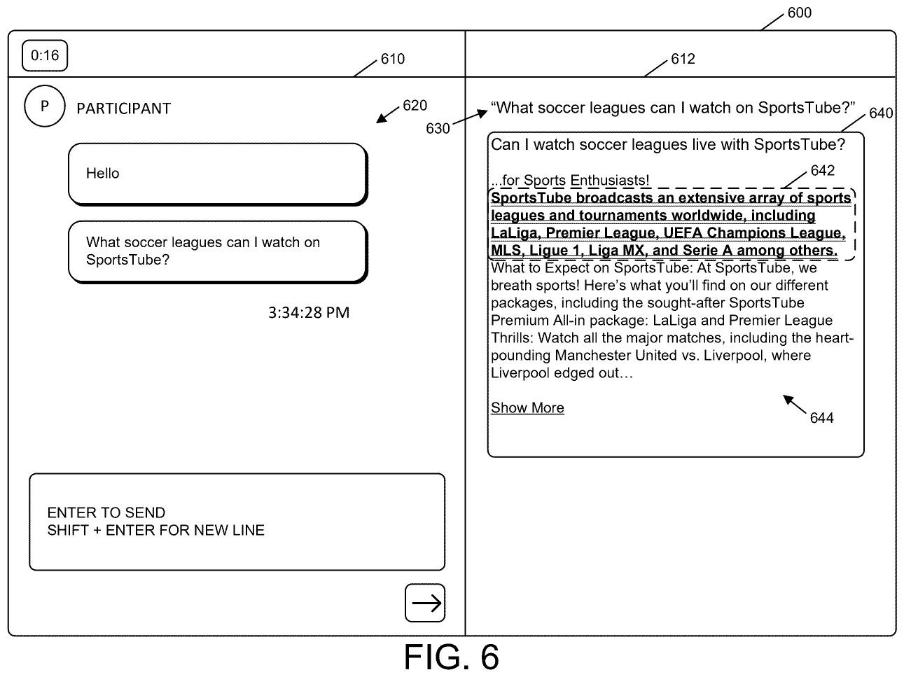

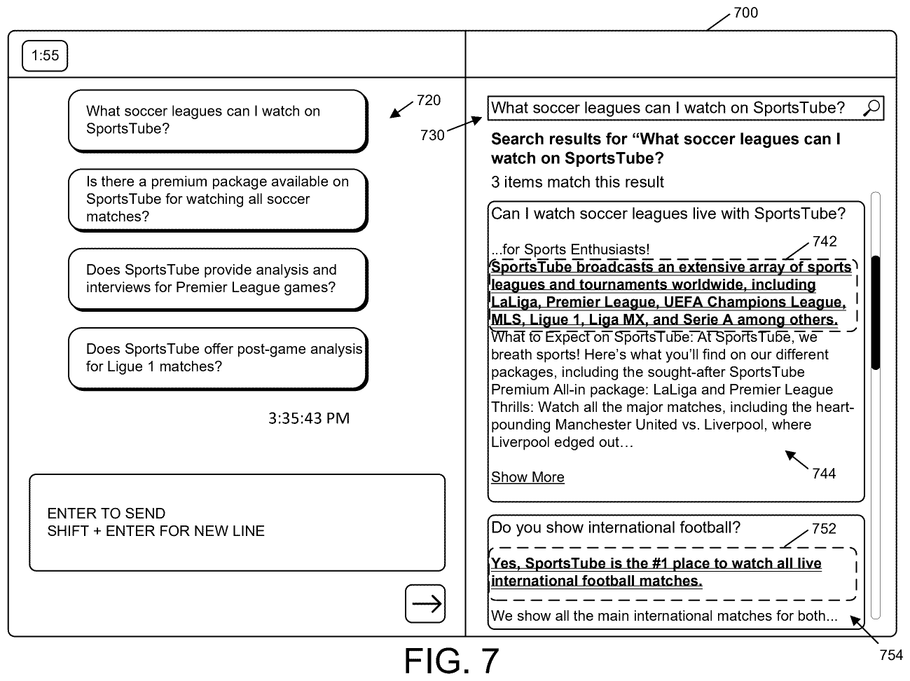

The illustrative method 300 begins with block 302 in which the computing system identifies a query associated with a contemporaneous (e.g., ongoing) interaction between a client and an agent of a contact center, such as the contact center system 100. The interaction is described in connection with the method 300 as a chat session. However, it should be understood that in other embodiments, the interaction may take place through a different channel, as described association with FIG. 1. In block 304, the computing system may identify the query in an auto-suggestion mode in which every client communication in the interaction represents a corresponding query. An embodiment of a user interface 600 associated with the auto-suggestion mode, in which the computing system treats each communication from the client as a corresponding query, is represented in FIG. 6. Alternatively, in block 306, the computing system may identify the query in a manual search mode in which the agent expressly provides (e.g., types) the query in association with the ongoing interaction. An embodiment of a user interface 700 associated with the manual search mode is represented in FIG. 7.

Continuing the method 300, in block 308, the computing system performs, as a function (e.g., based on) of the identified query, a search of a knowledge base (e.g., the storage device 114, which may be accessed by the knowledge system 124 and knowledge management server 122) to determine a set of one or more relevant documents. The term “document” is used herein to refer to any set of content that includes information that may be searched and retrieved from the knowledge base. As indicated in block 310, the computing system may perform a keyword search, a semantic search, and/or a hybrid search to identify the set of relevant document(s). In performing a keyword search, the computing system may search through the documents in the knowledge base to identify occurrences of exact matches of key words identified in the query. Further, the computing system may utilize a data set indicative of synonyms of the key words to broaden the keyword search beyond only the exact key words represented in the query. By contrast, in performing a semantic search, the computing system may utilize an understanding of the meaning associated with the query, based on natural language processing and one or more knowledge graphs indicative of distances or relationships between words, based on the underlying meanings of the words. In some embodiments, the computing system may perform a vector-based search that determines distances between a vector representation (an embedding) of the query and vector representations (embeddings) of the content of documents in the knowledge base to identify the nearest neighbors (e.g., those documents having the least distance to the query in an embedding space). In embodiments in which the computing system utilizes a hybrid search, the computing system may initially perform a keyword search to narrow down a set of documents from the knowledge base, then perform the semantic search on the resulting set to rank the documents in terms of semantic similarity or relevance to the query, as indicated in block 312. The computing system, in the illustrative embodiment, identifies, based on the ranking, a subset of the resultant documents as the set of relevant documents, in block 314. For example the computing system may select, from the ranking, the N most relevant documents as the set of relevant documents, in which N is a positive, non-zero integer.

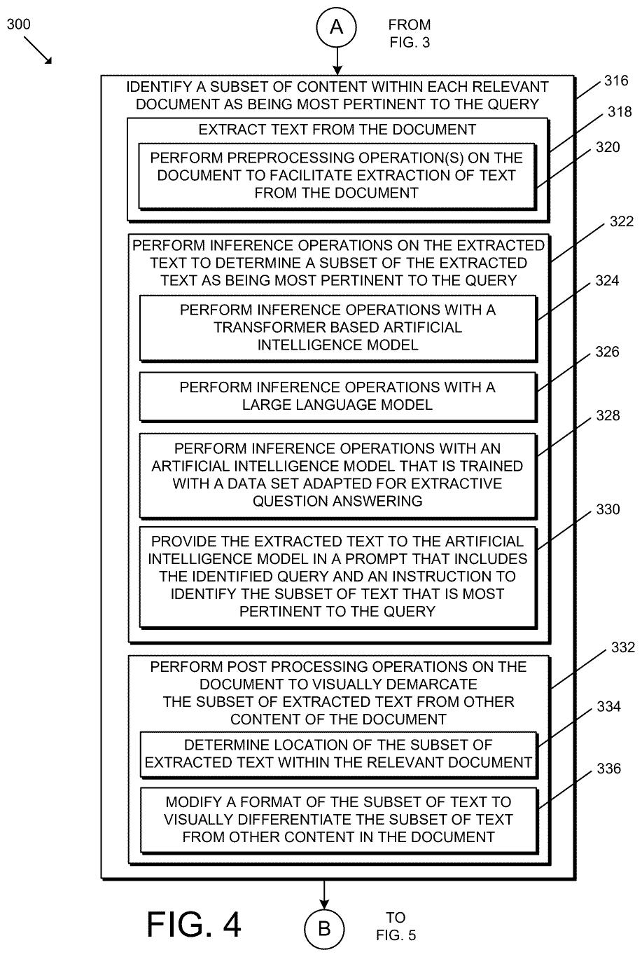

Continuing the method 300, in block 316 of FIG. 4, the computing system identifies a subset of content within each relevant document as being the most pertinent to the query. In doing so, the computing system extracts text from the document, as indicated in block 318. Further, in at least some embodiments, the computing system performs preprocessing operations on the document to facilitate extraction of text from the document, in block 320. In at least some embodiments, documents in the knowledge base may be in plain text format or encoded with a markup language, such as hyper text markup language (HTML). In the latter case, different structures within the document represent differing types of data or formatting, such as paragraphs, tables, images, etc. Documents may be defined using a custom markup schema as well. For example, a document may be encoded with a JSON-based structure with dictionary keys and values denoting various types of data or formatting. Multiple variations of the same document may be created using such schemas. In an example scenario, the computing system may receive, as input, content of a document in which multiple block types (e.g., table, paragraph, list item, etc.) are defined with a JSON-based structure. The computing system may extract text content from the JSON-based structure by recursively processing the JSON. In doing so, the computing system may recursively process the JSON and only extract text from selected block types. For example, the computing system may extract text only from paragraph and list blocks, while skipping over content from images and tables. The computing system may insert two new lines into the extracted text from each paragraph and may insert one new line into extracted text from every list item. The computing system may then clean the extracted text based on a set of criteria. For example, the computing system may replace specialized Unicode characters for spaces, dashes, and single quote symbols with other characters. The computing system may also replace ligatures with normalized equivalents thereof. Further, the computing system may remove any citation marks (e.g., “[12]”) from the extracted text using regular expressions. Further, the computing system may load artificial intelligence model and tokenizer files into memory with a dummy call (e.g., a placeholder call) to reduce initialization time for the first inference operation.

In block 322, the computing system, in the illustrative embodiment, performs inference operations on the extracted text to determine a subset of the extracted text as being the most pertinent to the query from block 302. The computing system may perform the inference operations with a transformer based artificial intelligence model, in block 324. A transformer based artificial intelligence model is a type of neural network. A neural network, also referred to herein as an artificial neural network, is a set of connected units or nodes that model the neurons in a brain and that are connected via edges, which model synapses in the brain. The nodes are arranged in layers (matrices), including an input layer, one or more hidden layers, and an output layer. Each neuron is configured to receive corresponding signals from connected neurons, then process those signals and produce a resulting signal to other connected neurons. The resulting signal is produced based on an activation function, which is a function that determines an output of a node based on the individual inputs and weights associated with those inputs. The activation function may be, for example, a rectified linear unit activation function, a gaussian error linear unit activation function, or a logistic sigmoid function.

In a transformer architecture, text is converted into a vector structure through a word embedding table, and in each of multiple layers of the architecture, the transformer contextualizes the token within the scope of a context window with other tokens through a parallel multi-head attention mechanism. Through the architecture, a signal for a key (e.g., significant) token may be amplified and the signal for a less significant token may be de-emphasized.

As indicated in block 326, the computing system may perform the inference operations with a large language model (LLM). A large language model is a type of machine learning model designed for natural language processing operations, including performing operations based on text-based prompts, and may be trained using supervised and unsupervised learning on a relatively large amount of text. An LLM may, in some embodiments, have a transformer architecture that includes an encoder and a decoder. The encoder and decoder extract meanings from a sequence of text and understand the relationships between words and phrases in it, such as based on embeddings. As described above, embeddings are vector based representations of words that represent semantic or contextual meanings of the words in a numeric format (e.g., as a multi-dimensional set of numbers).

The computing system may perform the inference operations with an artificial intelligence model (e.g., an LLM) that is trained with a data set that is adapted for extractive question answering, in block 328. That is the artificial intelligence model may be trained to identify an answer to a question by selecting a relevant span of text from a given context, by finding specific words or phrases in a larger set of text that directly provide an answer to a question (e.g., query) rather than generating a new answer. As such, the data set may include a set of documents, example queries, and corresponding answers based on those queries that have been previously determined to be correct. The data set may further include a verification data set on which the performance of the model, after being trained, can be verified to determine the accuracy of the model in providing answers to new questions.

In the illustrative embodiment, in block 330, the computing system provides the extracted text from block 318 to the artificial intelligence model in a prompt that also includes the identified query from block 302 and an instruction to identify the subset of text that is most pertinent to the query. In an example embodiment, the computing system pre-pends a prompt with the extracted text that directs the artificial intelligence model to generate answer highlights for a given query and context(s). Subsequently, the computing system calls a tokenizer to tokenize the text. Further, the computing system calls the artificial intelligence model to perform inference on the tokenized text and generate (e.g., identify the pertinent subset of the text) to be highlighted or otherwise visually demarcated.

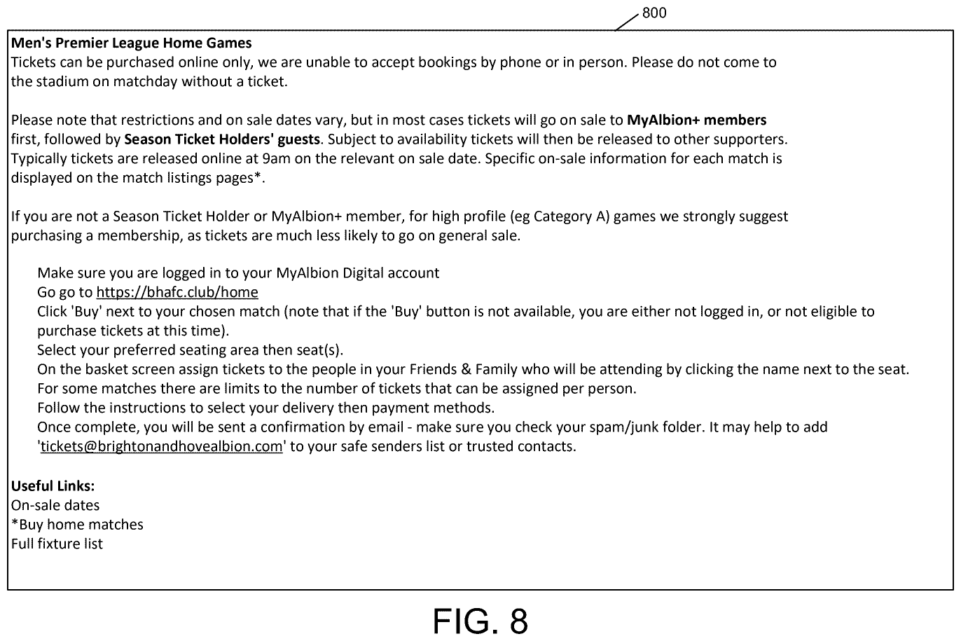

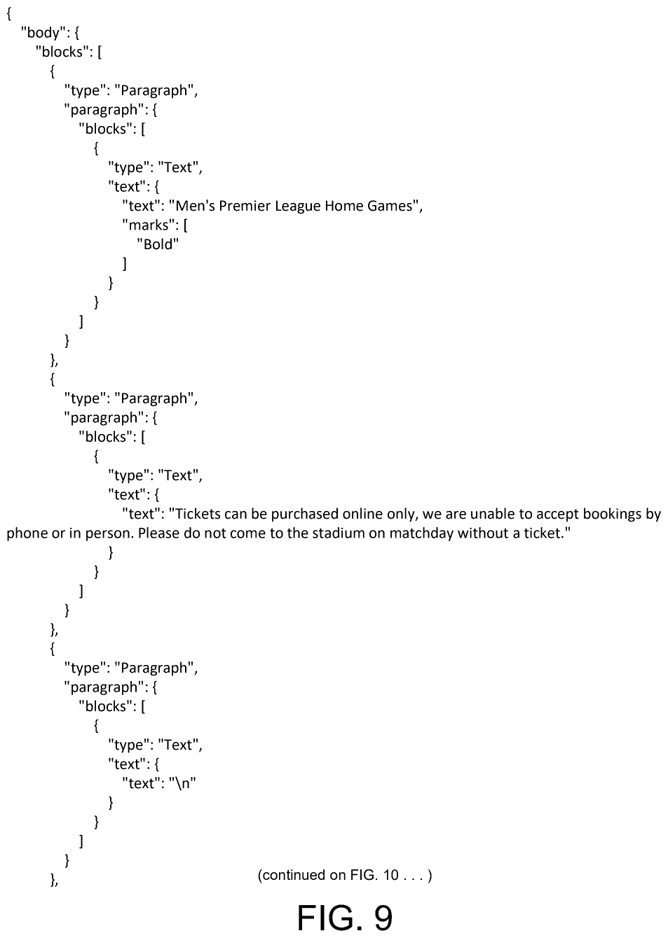

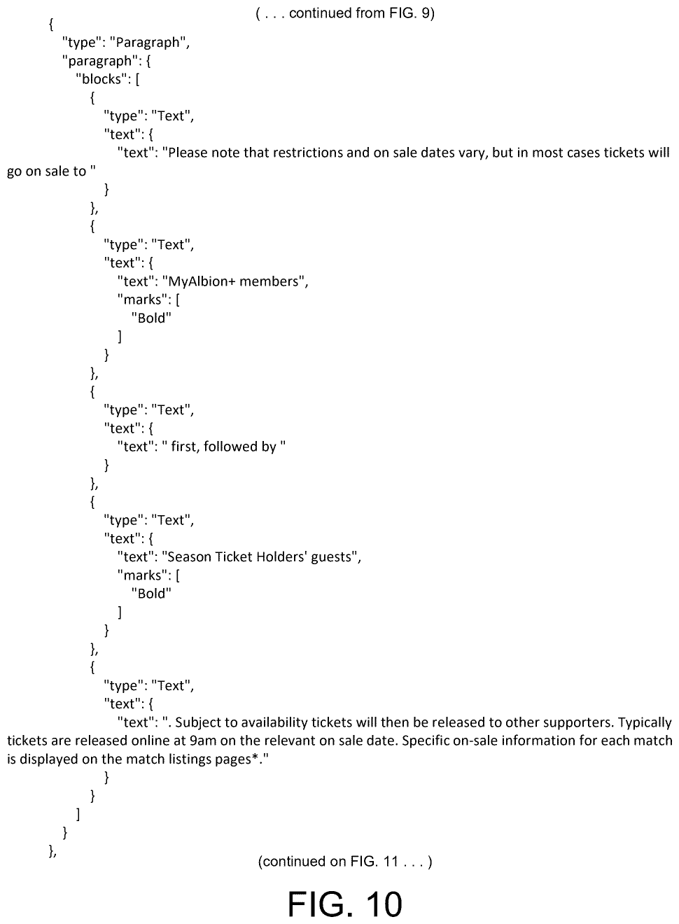

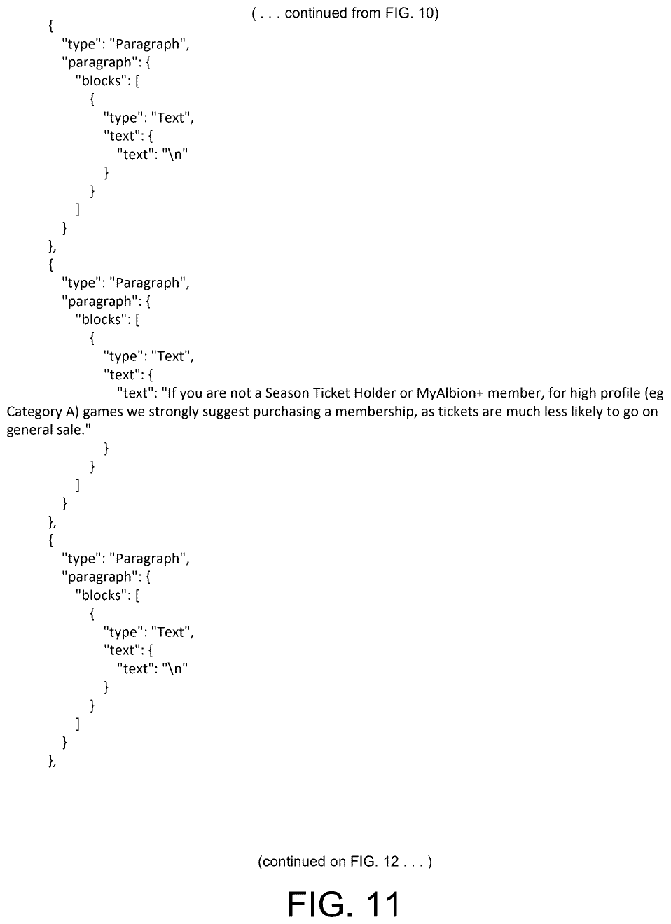

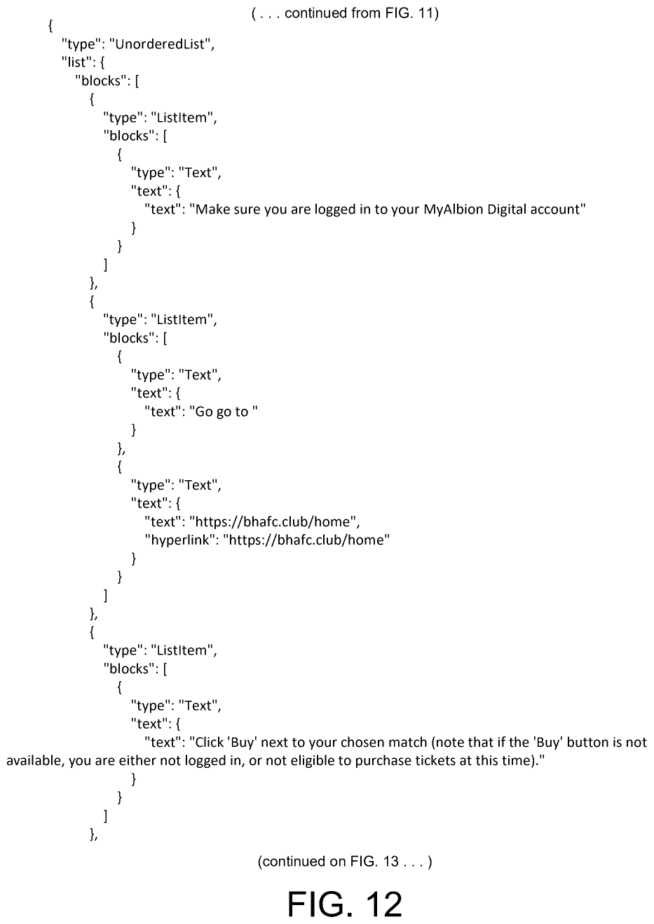

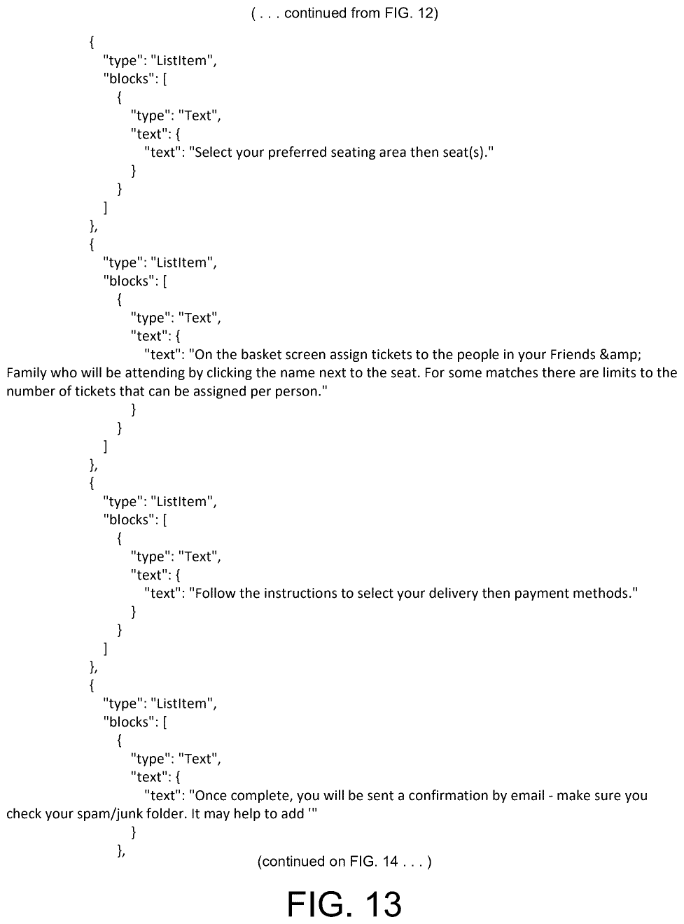

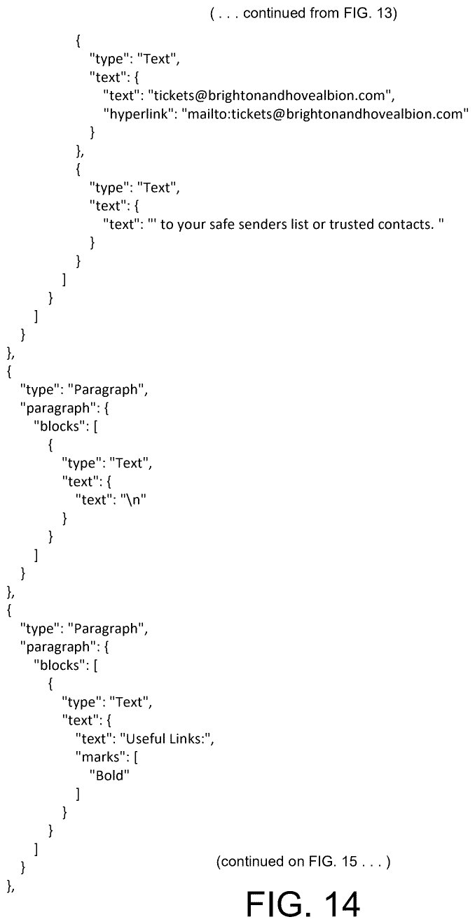

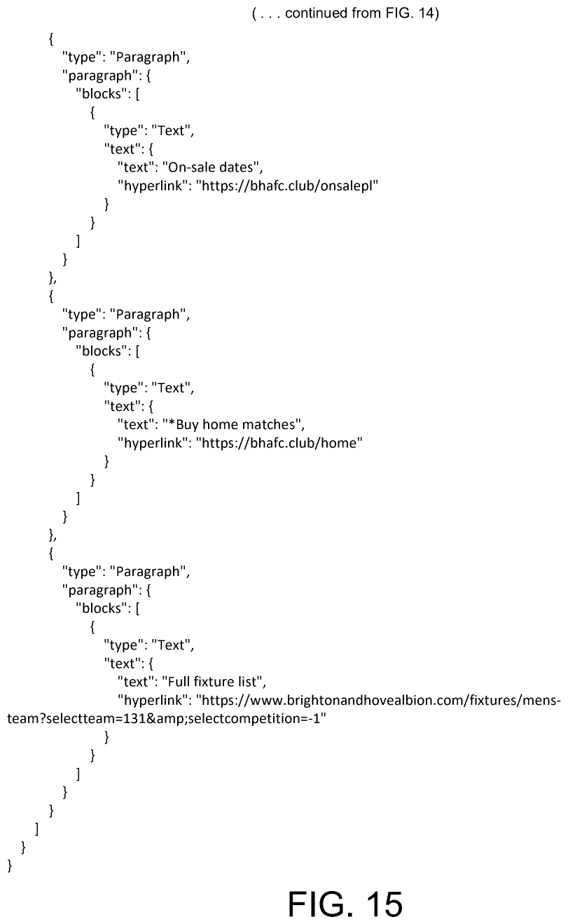

Further, in block 332, the computing system performs one or more post processing operations on the document to visually demarcate the subset of the extracted text determined by the artificial intelligence model as being the most pertinent to the query from the other content of the document. In doing so, the computing system determines the location, within the corresponding document, of the subset of the extracted text determined by the artificial intelligence model to be the most pertinent to the query, in block 334. Further, in block 336, the computing system may modify a format of the subset of text to visually differentiate the subset of text from other content in the document. That is, the computing system may modify, for example, one or more tags or other formatting data associated with the original encoding of the document, to indicate that the subset of text should be rendered differently from the surrounding content, such as through highlighting, bold font, different colors, underling, outlining, or other visual indicia. Continuing the example with a JSON-encoded document, once the computing system has determined the subset of pertinent text to be visually demarcated, the computing system identifies the relevant block(s) of text in the underlying document. The computing system may generate a list of the relevant blocks that contain at least a portion of the subset of the text that was determined to be most pertinent to the query. For each relevant block, the computing system may determine the start and end indices (e.g., positions), corresponding to the partial or full match of the pertinent text. The computing system may do so by comparing the pertinent text with the corresponding text block, one word at a time. Further, the computing system may generate a map of the relevant text block, identified using the actual text content of the block and a block index in the list of blocks, to the start and end indices. Additionally, the computing system may use the map to reinsert the indices in the original JSON structure, depending on whether re-insertion is enable via an input flag. The computing system may do so by recursively parsing the JSON and identifying the relevant block using the map, using logic similar to the preprocessing operation of extracting the text content from the JSON, described above. Further to the example provided above, FIG. 8 illustrates a rendered representation of a document 800 that may be present in the knowledge base and FIGS. 9-15 represent underlying encoding of the document in JSON.

In performing the inference operations, the computing system may utilize a transformer-based artificial intelligence model that is trained using open source data sets for extractive question answering, such as SQUAD 2.0. The model may be trained using multiple versions of such data sets based on varying length requirements of generated answer highlights (e.g., lengths of pertinent text). During training, lengths of output labels may be varied so that long, medium, and short sets of pertinent text may be extracted as answers by the artificial intelligence model.

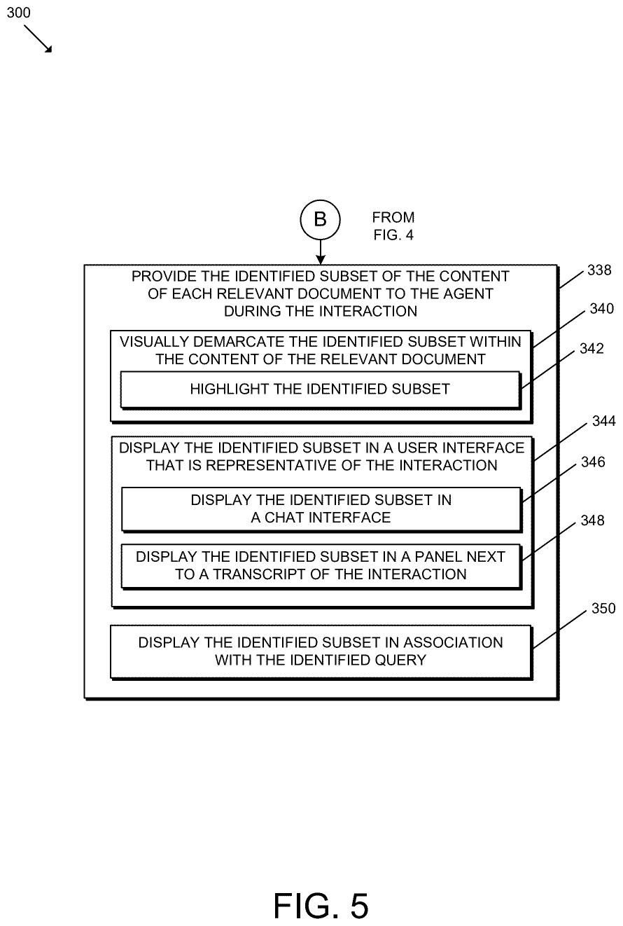

In the illustrative embodiment, the computing system performs the operations of block 316 for each relevant document. Continuing the method 300 in block 338 of FIG. 5, the computing system provides the identified subset of the content of each relevant document to the agent during the interaction with the client (e.g., in real time). In doing so, the computing system visually demarcates the identified subset of the content within the content of the relevant document, in block 340. For example, and as indicated in block 342, the computing system may highlight the identified subset to visually differentiate the subset from other content of the document. In block 344, the computing system may display the identified subset in a user interface that is representative of the interaction between the client and the agent. In doing so, in block 346, the computing system may display the identified subset of the content in a chat interface. In the illustrative embodiment, in block 348, the computing system displays the identified subset in a panel next to a transcript of at least a portion of the interaction. The computing system, in block 350, may display the identified subset in association with the identified query to provide context that indicates what question originating from the interaction the identified subset of content pertains to. Referring now to FIG. 6, a user interface 600 that may be produced by the computing system and displayed by an agent device 118A during an interaction, such as a chat session, with a client includes multiple panels 610, 612. The panel 610 includes a transcript 620 of the ongoing chat session with the client. As shown, the client has stated “Hello” and subsequently stated “What soccer leagues can I watch on SportsTube?”. In the auto-suggestion mode, the computing system has identified the client's question as a query 630. A result 640 indicative of a relevant document identified by the computing system from the knowledge base is represented in the panel 612. Further, within content of the relevant document, the text 642 that was identified by the computing system as being most pertinent to the query is visually differentiated (e.g., demarcated) from other content 644 of the document.

Similarly, and referring now to FIG. 7, a user interface 700 that may be produced by the computing system and displayed by the agent device 118A during an interaction (e.g., the interaction represented in FIG. 6) represents further operation of the computing system, but in a manual search mode. The user interface 700 includes an updated transcript 720 of the interaction in which further communications from the client have been received. Further, the user interface 700 includes a query 730 that was expressly entered by the agent. Within documents returned by the search operations, the text 742, 752 determined to be most pertinent within the each document content is visually demarcated from the surrounding document content 744, 754.

What is claimed is:

1. A method for efficient identification of knowledge base data to support interactions in a contact center, the method comprising:
identifying, by a computing system, a query associated with a contemporaneous interaction between a client and an agent of a contact center;
performing, by the computing system and as a function of the identified query, a search of a knowledge base to determine a set of one or more relevant documents responsive to the identified query, including ranking a set of resultant documents from the knowledge base as a function of a vector-based similarity determination in which each resultant document and the identified query is represented with a corresponding embedding;
identifying, by the computing system and with a transformer-based artificial intelligence model trained to perform extractive question answering, a subset of content within each relevant document as being most pertinent to the identified query; and
providing, by the computing system, the identified subset of the content of each relevant document to the agent during the interaction, including visually demarcating the identified subset of each relevant document from other content of the relevant document in a user interface that is representative of the interaction as the interaction occurs.

2. The method of claim 1, wherein identifying the query comprises identifying, in an auto-suggestion mode, each of multiple communications of the client in the interaction as a separate query.

3. The method of claim 1, wherein identifying the query comprises identifying a query provided by the agent via the user interface that is representative of the interaction during the interaction.

4. The method of claim 1, wherein identifying the subset of the content within each relevant document comprises:
extracting text from each relevant document;
performing, with the artificial intelligence model, inference operations on the extracted text to determine a subset of the extracted text as being most pertinent to the query; and
performing post processing operations on each relevant document to demarcate the subset of extracted text from other content of the relevant document, including determining the location of the subset of the extracted text within the relevant document.

5. The method of claim 1, wherein performing inference operations further comprises providing the extracted text to the artificial intelligence model in a prompt that includes the identified query and an instruction to identify the subset of text that is most pertinent to the identified query.

6. The method of claim 1, wherein performing inference operations with a transformer based artificial intelligence model comprises performing the inference operations with a large language model.

7. The method of claim 1, wherein visually demarcating the identified subset of each relevant document comprises highlighting the identified subset of each relevant document in the user interface.

8. The method of claim 1, wherein providing the identified subset of the content of each relevant document to the agent comprises displaying the identified subset in conjunction with a transcript of at least a portion of the interaction in the user interface.

9. The method of claim 1, wherein providing the identified subset of the content of each relevant document to the agent comprises displaying the identified subset in a chat interface that is representative of the interaction.

10. The method of claim 1, wherein providing the identified subset of the content of each relevant document to the agent comprises displaying the identified query with the identified subset of the content.

11. A system for efficient identification of knowledge base data to support interactions in a contact center, the system comprising:
at least one processor; and
at least one memory comprising a plurality of instructions stored thereon that, in response to execution by the at least one processor, causes the system to:
identify a query associated with a contemporaneous interaction between a client and an agent of a contact center;
perform, as a function of the identified query, a search of a knowledge base to determine a set of one or more relevant documents responsive to the identified query, wherein to perform the search includes to rank a set of resultant documents from the knowledge base as a function of a vector-based similarity determination in which each resultant document and the identified query is represented with a corresponding embedding;
identify, with a transformer-based artificial intelligence model trained to answer questions with text extraction, a subset of content within each relevant document as being most pertinent to the identified query; and
provide the identified subset of the content of each relevant document to the agent during the interaction, wherein to provide the identified subset includes to visually demarcate the identified subset of each relevant document from other content of the relevant document in a user interface that is representative of the interaction as the interaction occurs.

12. The system of claim 11, wherein to identify the query comprises to identify, in an auto-suggestion mode, each of multiple communications of the client in the interaction as a separate query.

13. The system of claim 11, wherein to identify the query comprises to identify a query provided by the agent via the user interface that is representative of the interaction during the interaction.

14. The system of claim 11, wherein to identify the subset of the content within each relevant document comprises to:
extract text from each relevant document;
perform, with the artificial intelligence model, inference operations on the extracted text to determine a subset of the extracted text as being most pertinent to the query; and
perform post process operations on each relevant document to demarcate the subset of extracted text from other content of the relevant document, wherein to perform the post process operations include to determine the location of the subset of the extracted text within the relevant document.

15. The system of claim 11, wherein to perform inference operations further comprises to provide the extracted text to the artificial intelligence model in a prompt that includes the identified query and an instruction to identify the subset of text that is most pertinent to the identified query.

16. The system of claim 11, wherein to perform inference operations with a transformer based artificial intelligence model comprises to perform the inference operations with a large language model.

17. The system of claim 11, wherein to visually demarcate the identified subset of each relevant document comprises to highlight the identified subset of each relevant document in the user interface.

18. The system of claim 11, wherein to provide the identified subset of the content of each relevant document to the agent comprises to display the identified subset in conjunction with a transcript of at least a portion of the interaction in the user interface.

19. The system of claim 11, wherein to provide the identified subset of the content of each relevant document to the agent comprises to display the identified subset in a chat interface that is representative of the interaction.

20. The system of claim 11, wherein to provide the identified subset of the content of each relevant document to the agent comprises to display the identified query with the identified subset of the content.
